(19) United States
(12) Patent Application Publication
(10) Pub. No.: US 2004/0078451 A1
(43) Pub. Date: Apr. 22, 2004

(54) Separating and saving hyperlinks of special interest from a sequence of web documents being browsed at a receiving display station on the web

(75) Inventors: Timothy Alan Dietz, Austin, TX (US); Walid Kobrosly, Round Rock, TX (US); Nadeem Malik, Austin, TX (US)

Correspondence Address: Mark E. McBurney, International Business Machines Corporation, Intellectual Property Law Department, 11400 Burnet Road - 4054, Austin, TX, 78758, US

(73) Assignee: International Business Machines Corporation, Armonk, NY

(21) Appl. No.: 10/273,640

(22) Filed: Oct. 17, 2002

(51) Int. Cl. G06F 15/16

(52) U.S. Cl. 709/217

(57) ABSTRACT

The user at a receiving display station is enabled to make an overall scan of a sequence of Web documents developed in a search of the Web, and to select and save hyperlinks that appear to be of potential interest from any or all of the sequence of Web documents. A user is enabled to selectively move hyperlinks from any of a sequence of hypertext documents to a display window to thereby compile a list of hyperlinks having potential interest. The user is then enabled to subsequently select hyperlinks from said list to thereby access the linked hypertext documents; i.e. the user may subsequently, at his convenience, browse through the hyperlinks that he has selected and saved. A window is set aside on the display for the display of the saved hyperlinks. Conveniently, the means to selectively move hyperlinks include means for dragging selected hyperlinks from their hypertext documents and dropping the hyperlinks into the display window.

### CROSS-REFERENCE TO COPENDING APPLICATION

Copending Application: HIGHLIGHTING WORLD WIDE WEB DOCUMENTS OF SPECIAL INTEREST IN A DISPLAYED SESSION HISTORY LIST OF WEB DOCUMENTS RECEIVED DURING A WEB ACCESS SESSION AT A RECEIVING WEB DISPLAY STATION, G. F. McBrearty et al., Ser. No. 09/714,734, filed Nov. 16, 2000, and assigned to the same assignee as the present Application.

### TECHNICAL FIELD

The present invention relates to computer managed communication networks such as the World Wide Web (Web) and, particularly, to systems, processes and programs for reducing users' time spent in accessing and browsing through numerous Web documents that may be of possible interest to the user.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct hyperlinks between Web pages embedded in such Web pages. This even further exploded the use of the Internet or Web. It was now possible for the Web browser or wanderer to spend literally hours going through document after document in often less than productive excursions through the Web. These excursions often strained the users' time and resources. A significant source of this drain is in the Web page itself (the basic document page of the Web).

Web documents or pages have hyperlinks setting forth terms and topics that the user may interactively click on or select to access other Web documents that, in turn, respectively have their own hyperlinks selectable by the user to access the next Web documents. Thus, browsing through Web documents often involves the time consuming process of following a thread of hyperlinked Web documents through several levels of hyperlinks, then backing up to a Web document at an earlier level, selecting another hyperlink in that document and then following another thread of hyperlinked documents through several levels.

Web developers and users are continually seeking implementations to make this Web document browsing process less cumbersome and more user friendly. At present, there are many effective browsing routines by which the user may backtrack through where he has been and passed through in his navigation of the Web in a particular session. While these approaches certainly do help the user in relocating Web pages and documents of interest, as well as particular hyperlinks on these pages of interest, they still require that the user spend considerable time going through documents in the backtracked sequence that are of little or no interest. It should also be considered that the organization of Web pages and their hyperlinks are based upon what is of universal or global user interest. On the other hand, the particular user's interests may be quite specific and not follow any universal logic.

### SUMMARY OF THE PRESENT INVENTION

The present invention addresses the browsing user's particular needs in browsing through the Web by enabling the user to make an overall scan of a sequence of Web documents developed in a search of the Web, and to select and save hyperlinks that appear to be of potential interest from any or all of the sequence of Web documents. Accordingly, the present invention applies to a communication network like the Web or Internet (the two terms are used interchangeably herein) with user access via a plurality of data processor controlled interactive receiving display stations for displaying received hypertext documents of at least one display page containing embedded hyperlinks to other hypertext documents accessible from sources on the network. The invention provides a system enabling a user to separate hyperlinks of potential interest out of a sequence of received hypertext documents comprising means at a receiving display station enabling a user to selectively move hyperlinks from any of a sequence of hypertext documents to a display window to thereby compile a list of hyperlinks having potential interest in combination with means enabling a user at said receiving display station to subsequently select hyperlinks from said list to thereby access the linked hypertext documents; i.e. the user may subsequently, at his convenience, browse through the hyperlinks that he has selected and saved. A window is set aside on the display for the display of the saved hyperlinks. Conveniently, the means to selectively move hyperlinks include means for dragging selected hyperlinks from their hypertext documents and dropping the hyperlinks into the display window. While he is selecting and saving hyperlinks by moving such hyperlinks in windows, the user still retains the option of conventionally selecting hyperlinks from any of said sequence of received hypertext documents to thereby access the linked or secondary hypertext documents in the standard way. In such a case, of course, the user remains enabled to then selectively move hyperlinks from any of said linked or secondary hypertext documents to said display window to thereby add said hyperlinks to the list of hyperlinks having potential interest.

As will be seen hereinafter in greater detail, the searching and browsing at the receiving display station is preferably controlled by a Web browser that will include the means enabling a user to selectively move hyperlinks from any of said sequence of hypertext documents to a display window, and the means enabling a user to subsequently select hyperlinks from said list to thereby access the linked hypertext documents. The Web browser should also include the above-mentioned Web searching means for accessing the sequence of received hypertext documents, as well as the conventional means for selecting hyperlinks from any of said sequence of received hypertext documents to thereby access the linked hypertext documents, and the means for then enabling a user to selectively move hyperlinks from any of said linked hypertext documents to said display window to thereby add said hyperlinks to the list of hyperlinks having potential interest.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the receiving display station on which hyperlinks from Web documents may be separated and saved in a window;

FIG. 2 is a generalized diagrammatic view of a Web portion upon which the present invention may be implemented;

FIG. 3 is a diagrammatic view of a Web page illustrating how a hyperlink may be separated and stored in a window;

FIG. 4 is the diagrammatic view of the Web page of FIG. 3 illustrating how a set of hyperlinks may be separated and stored in the window;

FIG. 5 is the diagrammatic view of a Web page in a sequence subsequent to the Web page of FIGS. 3 and 4 illustrating how a set of hyperlinks may be separated and stored in the window from the sequence of Web pages;

FIG. 6 is an illustrative flowchart describing the setting up of the process of the present invention for hyperlinks from a sequence of Web pages being separated and saved in a window; and

FIG. 7 is a flowchart of an illustrative run of the process set up in FIG. 6.

### DETAILED DESCRIPTION OF THE PREFERRED EMBODIMENT

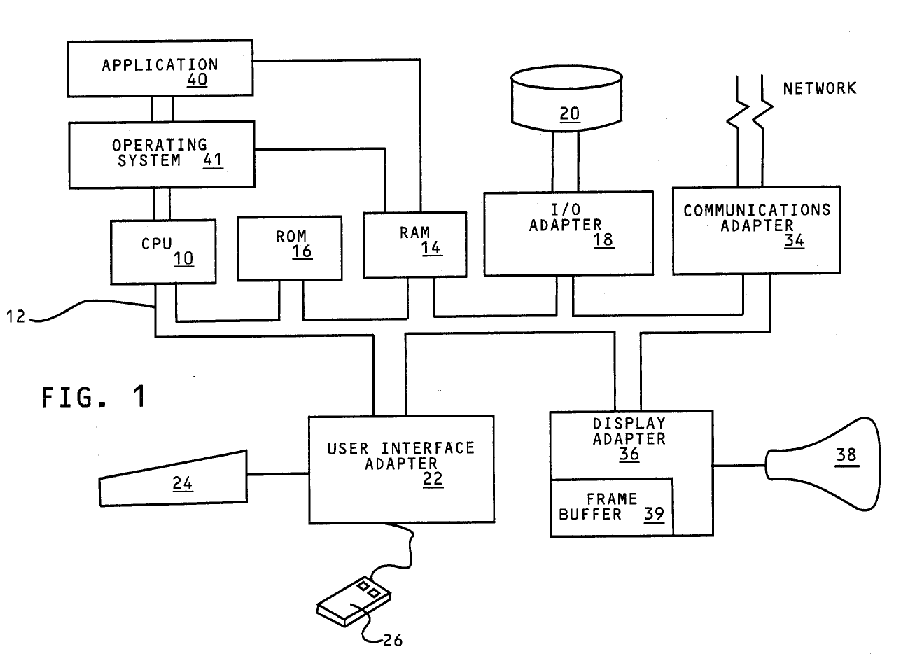

Referring to FIG. 1, a typical data processing terminal is shown that may function as the Web display station on which the sequence of Web pages may be browsed, and the hyperlinks of interest separated and stored in a window. A central processing unit (CPU) 10, may be one of the commercial microprocessors in personal computers available from International Business Machines Corporation (IBM) or Dell Corporation; or a workstation, e.g. RISC System/6000™ (RS/6000) series available from IBM. The CPU is interconnected to various other components by system bus 12. An operating system 41 runs on CPU 10, provides control and is used to coordinate the function of the various components of FIG. 1. Operating system 41 may be one of the commercially available operating systems, such as the AIX™ operating systems available from IBM; Microsoft's Windows XP™ or Windows2000™, as well as UNIX and LINUX operating systems. Application programs 40, controlled by the system, are moved into and out of the main memory Random Access Memory (RAM) 14. These programs include the programs of the present invention for enabling the user to selectively move hyperlinks from any of a sequence of Web pages into a window. These programs will be subsequently described in combination with any conventional Web browser, such as the Netscape Navigator™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with the outside network, e.g. the Web. The terms, Web or Internet, are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components; such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since the major aspect of the present invention is directed to Web pages transmitted over global networks, such as the Web or Internet, an understanding of networks and their operating principles would be helpful. We will not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999. Any data communication system that interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text at Chapter 19, pp. 419-454, on the Netscape Navigator; Chapter 20, pp. 455-494, on the Microsoft Internet Explorer; and Chapter 21, pp. 495-512, covering Lynx, Opera and other browsers.

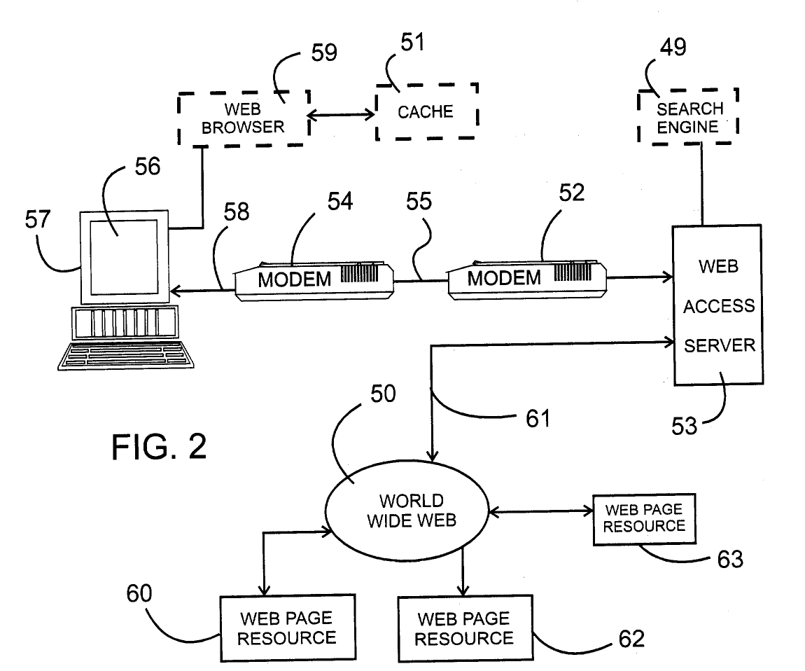

A generalized diagram of a portion of the Web, to which the computer controlled display terminal 57 used for Web page receiving during searching or browsing, is connected as shown in FIG. 2. Computer display terminal 57 may be implemented by the computer system set up in FIG. 1, and connection 58 (FIG. 2) is the network connection shown in FIG. 1. For purposes of the present embodiment, computer 57 serves as a Web display station and has received displayed Web page 56, which is one of a sequence of Web pages containing embedded hyperlinks to other Web pages. Reference may be made to the above-mentioned Mastering the Internet, pp. 136-147, for typical connections between local display stations to the Web via network servers, any of which may be used to implement the system on which this invention is used. The system embodiment of FIG. 2 has a host-dial connection. Such host-dial connections have been in use for over 30 years through network access servers 53 that are linked 61 to the Web 50. The servers 53 may be maintained by a service provider to the client's display terminal 57. The host's server 53 is accessed by the client terminal 57 through a normal dial-up telephone linkage 58 via modem 54, telephone line 55 and modem 52. The HTML file representative of the Web page 56 has been downloaded to display terminal 57 through Web access server 53 via the telephone line linkages from server 53, which may have accessed them from the Internet 50 via linkage 61. The Web browser program 59 operates within the display terminals 57 to control the communication with the Web access server 53 to thereby download and display the accessed Web pages 56 on terminal 57. The Web access server 53 uses any search engines to access via the Web 50 and obtain Web documents from appropriate Web resources, such as databases 60, 62 and 63.

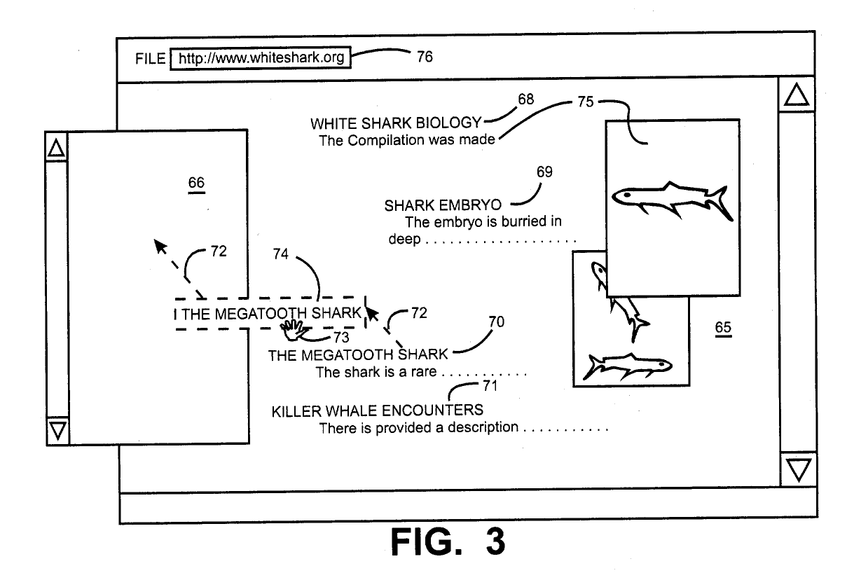

With this set up, the present invention, which will be subsequently described in greater detail with respect to FIGS. 3 through 5, may be carried out using Web browser 59 and associated cache 51 (FIG. 2) to create a window of hyperlinks of special interest selected for future browsing from a sequence of hypertext Web pages. In FIG. 3, there is shown a Web page 65 from a sequence of pages developed in a search. With reference to FIG. 2 such searches are conducted as defined through browser 59 by an appropriate search engine accessed via Web server 53. As described in the above-mentioned Internet: The Complete Reference, Millenium Edition text, pp. 395 and 522-535, search engines use keywords and phrases to query the Web for desired subject matter. In carrying out its search, the search engine looks through the database for matches to keywords subject to the engine syntax. The search engine then presents to the user a list of the Web pages it determines to be closest to the requested query. Some significant search engines are: AltaVista, Infoseek, Lycos, Magellan, Webcrawler and Yahoo.

The Web page 65, FIG. 3, has a URL, “White Shark” 76, text and images 75, as well as several hyperlinks 68, 69, 70 and 71 to other Web pages. There is a window 66 for saving hyperlinks for future browsing of their respective Web pages. In the illustration, the user has selected hyperlink 70 for such saving. It is interactively grasped by user controlling hand pointer 73 which drags the image 74 of hyperlink 70 along path 72 into window 66.

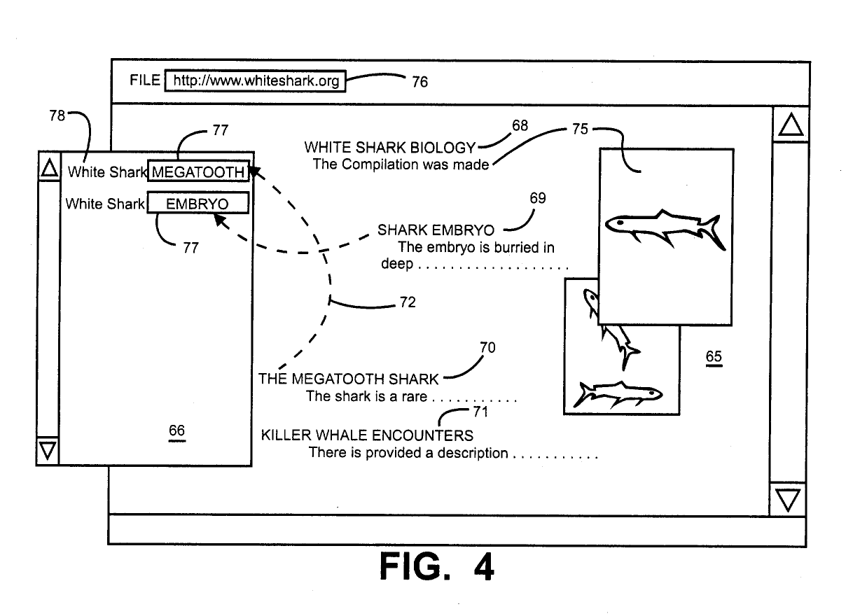

FIG. 4 shows the Web page of FIG. 3 at a later stage. In the meantime, another hyperlink, “Shark Embryo” 69, has had its image dragged along a path 72 also into window 66 where there are now two stored hyperlinks 77, identified by their respective names, “Embryo” and “Megatooth”, as well as their Web page URL “White Shark” 78.

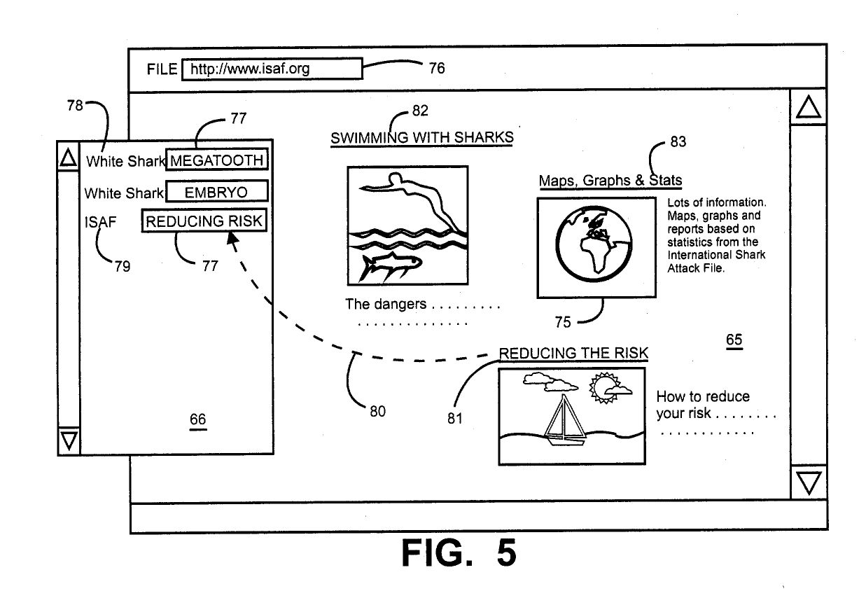

FIG. 5 shows the set up subsequently when another Web page 65 in the search result sequence having a URL, “ISAF” 76, has been displayed. This page also has images and text 75, and several hyperlinks, 81, 82 and 83 of which the user has selected hyperlink 81 for future reference, and, thus, has interactively dragged it along path 80 into window 66 where the hyperlink is identified by its name, “Reducing Risk” 77, and its URL 79. With the hyperlinks 77 saved in window 65, the user may select any of these hyperlinks to be accessed and view their linked page at the user's convenience.

FIG. 5 is a flowchart showing the development of a process according to the present invention for the saving of hyperlinks from any of a sequence of Web pages by moving the hyperlinks into a common window. At a receiving display station on the Web, a Web browser is provided with a capability of conventionally having Web search engines perform conventional Web database searching, step 84. The Web browser is provided with the conventional capability of presenting to the user a sequence of Web pages each having hyperlinks to other Web pages, step 85. The Web browser has the further conventional capability of enabling the user to click on the hyperlinks in the Web pages to thereby access the linked Web pages, step 86. A special Window is provided for storing and displaying selected hyperlinks to be moved into the window, step 87. The browser is provided with a routine whereby the user through mouse pointer control is enabled to select and drag any hyperlink from its Web page and to drop the hyperlink in the window to form a list of such selected hyperlinks, step 88. The browser is provided with the capability of storing the addresses of the Web pages linked to each respective stored hyperlink, step 89. The browser is provided with an implementation whereby the user may subsequently interactively select any hyperlink listed in the window to thereby activate the browser to access and display the linked Web page, step 90.

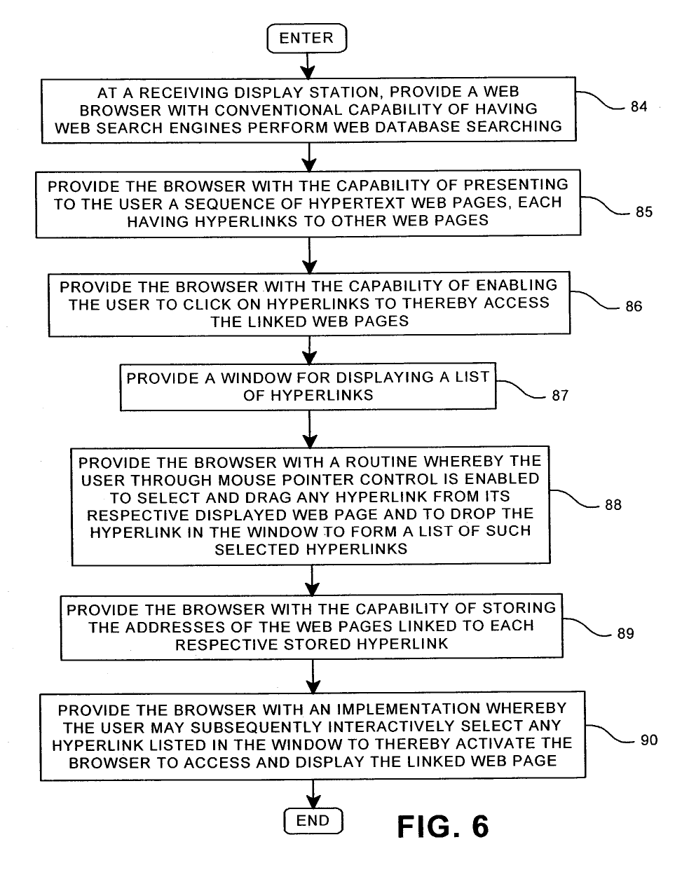

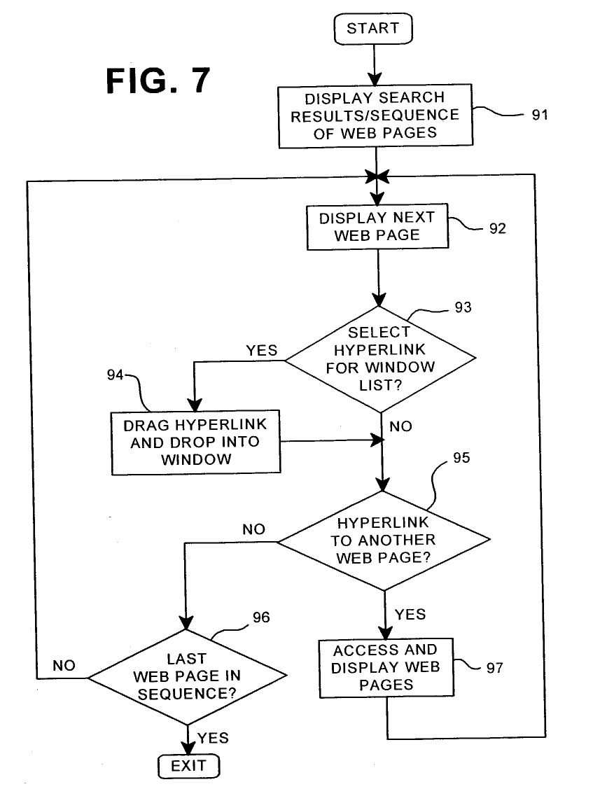

The running of the process set up in FIG. 6 and described in connection with FIGS. 3 through 5 will now be described with respect to the flowchart of FIG. 7. Let us assume that we are in a Web browsing session through the browser. The flowchart represents some steps in a routine that will illustrate the operation of the invention. The browser has just had a search done resulting in a sequence of Web pages that the browser is displaying in sequence at the receiving display station, step 91. The next page in the sequence is displayed, step 92. Then, a determination is made as to whether the user has selected a hyperlink to be saved in his window list, step 93. If Yes, the hyperlink is dragged from its page and dropped in the window, step 94. Then, or if the determination from step 93 is No, a further determination is made as to whether the user has selected to conventionally activate a hyperlink to access another Web page, step 95. If Yes, that Web page is accessed, step 97, and the process is branched back to step 92 where the accessed Web page is treated as the next Web page and the process is continued as described hereinabove. If the determination in step 95 is No, then a determination is made, step 96, as to whether the instant Web page is the last page in the sequence. If Yes, the session is exited. If No, the process is branched back to step 92 where the next Web page is accessed and the process is continued as described hereinabove.

One of the preferred implementations of the present invention is in application program 40, i.e. a browser program made up of programming steps or instructions resident in RAM 14, FIG. 1, of a Web receiving station during various Web operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a World Wide Web (Web) communication network with user access via a plurality of data processor controlled interactive receiving display stations for displaying received hypertext documents of at least one display page containing embedded hyperlinks to other hypertext documents accessible from sources on the Web, a system enabling a user to separate hyperlinks of potential interest out of a sequence of received hypertext documents comprising:
means at a receiving display station enabling a user to selectively move hyperlinks from any of said sequence of hypertext documents to a display window to thereby compile a list of hyperlinks having potential interest; and
means enabling a user at said receiving display station to subsequently select hyperlinks from said list to thereby access the linked hypertext documents.

2. The Web network system of claim 1 wherein said means to selectively move hyperlinks include means for dragging and dropping selected hyperlinks from their hypertext documents into said display window.

3. The Web network system of claim 1 further including Web searching means for accessing said sequence of received hypertext documents.

4. The Web network system of claim 3 further including:
means for selecting hyperlinks from any of said sequence of received hypertext documents to thereby access the linked hypertext documents; and
means enabling a user to selectively move hyperlinks from any of said linked hypertext documents to said display window to thereby add said hyperlinks to the list of hyperlinks having potential interest.

5. The Web network system of claim 2 wherein said receiving display station further includes a user interactive Web browser, said Web browser including:
said means enabling a user to selectively move hyperlinks from any of said sequence of hypertext documents to a display window; and
said means enabling a user to subsequently select hyperlinks from said list to thereby access the linked hypertext documents.

6. The Web network system of claim 5 wherein said Web browser further includes:
Web searching means for accessing said sequence of received hypertext documents;
means for selecting hyperlinks from any of said sequence of received hypertext documents to thereby access the linked hypertext documents; and
means enabling a user to selectively move hyperlinks from any of said linked hypertext documents to said display window to thereby add said hyperlinks to the list of hyperlinks having potential interest.

7. In a Web communication network with user access via a plurality of data processor controlled interactive receiving display stations for displaying received hypertext documents of at least one display page containing embedded hyperlinks to other hypertext documents accessible from sources on the Web, a method enabling a user to separate hyperlinks of potential interest out of a sequence of received hypertext documents comprising:
enabling a user at a receiving display station to selectively move hyperlinks from any of said sequence of hypertext documents to a display window to thereby compile a list of hyperlinks having potential interest; and
enabling a user at said receiving display station to subsequently select hyperlinks from said list to thereby access the linked hypertext documents.

8. The method of claim 7 of enabling a user to selectively move hyperlinks includes the steps of dragging selected hyperlinks from their hypertext documents and dropping said dragged hyperlinks into said display window.

9. The method of claim 7 further including the step of the Web to access said sequence of received hypertext documents.

10. The method of claim 9 further including the steps of:
selecting hyperlinks from any of said sequence of received hypertext documents to thereby access the linked hypertext documents; and
enabling a user to selectively move hyperlinks from any of said linked hypertext documents to said display window to thereby add said hyperlinks to the list of hyperlinks having potential interest.

11. The method of claim 8 wherein including a user interactive Web browser method, said Web browser method including:
said step of enabling a user to selectively move hyperlinks from any of said sequence of hypertext documents to a display window; and
said step of enabling a user to subsequently select hyperlinks from said list to thereby access the linked hypertext documents.

12. The method of claim 11 wherein said Web method further includes the steps of:
searching the Web to access said sequence of received hypertext documents;
selecting hyperlinks from any of said sequence of received hypertext documents to thereby access the linked hypertext documents; and
enabling a user to selectively move hyperlinks from any of said linked hypertext documents to said display window to thereby add said hyperlinks to the list of hyperlinks having potential interest.

13. A computer program having code recorded on a computer readable medium for enabling a user to separate hyperlinks of potential interest out of a sequence of received hypertext documents in a Web communication network with user access via a plurality of data processor controlled interactive receiving display stations for displaying received hypertext documents of at least one display page containing embedded hyperlinks to other hypertext documents accessible from sources on the Web, said program comprising:
means at a receiving display station enabling a user to selectively move hyperlinks from any of said sequence of hypertext documents to a display window to thereby compile a list of hyperlinks having potential interest; and
means enabling a user at said receiving display station to subsequently select hyperlinks from said list to thereby access the linked hypertext documents.

14. The computer program of claim 13 wherein said means to selectively move hyperlinks include means for dragging and dropping selected hyperlinks from their hypertext documents into said display window.

15. The computer program of claim 13 further including Web searching means for accessing said sequence of received hypertext documents.

16. The computer program of claim 15 further including:
means for selecting hyperlinks from any of said sequence of received hypertext documents to thereby access the linked hypertext documents; and
means enabling a user to selectively move hyperlinks from any of said linked hypertext documents to said display window to thereby add said hyperlinks to the list of hyperlinks having potential interest.

17. The computer program of claim 14 wherein said receiving display station further includes a user interactive Web browser, said Web browser including:
said means enabling a user to selectively move hyperlinks from any of said sequence of hypertext documents to a display window; and
said means enabling a user to subsequently select hyperlinks from said list to thereby access the linked hypertext documents.

18. The computer program of claim 17 wherein said Web browser further includes:
Web searching means for accessing said sequence of received hypertext documents;
means for selecting hyperlinks from any of said sequence of received hypertext documents to thereby access the linked hypertext documents; and
means enabling a user to selectively move hyperlinks from any of said linked hypertext documents to said display window to thereby add said hyperlinks to the list of hyperlinks having potential interest.

19. A user interactive display interface for a data processor controlled receiving display station in a Web communication network for displaying hypertext documents of at least one display page containing embedded hyperlinks to other hypertext documents accessed from sources on the Web enabling a user to separate hyperlinks of potential interest out of a sequence of received hypertext documents comprising:
a display window;
a device enabling a user to selectively move hyperlinks from any of said sequence of hypertext documents into said display window to thereby compile a list of hyperlinks having potential interest; and
a device enabling a user to subsequently select hyperlinks from said list to thereby access the linked hypertext documents.

20. The user interactive display interface of claim 19 wherein said device for enabling the user to selectively move hyperlinks includes an implementation for dragging selected hyperlinks from their hypertext documents and dropping said selected hyperlinks into said display window.

21. The user interactive display interface of claim 19 further including a Web searching engine for accessing said sequence of received hypertext documents.

22. The user interactive display interface of claim 21 further including:
a device for selecting hyperlinks from any of said sequence of received hypertext documents to thereby access the linked hypertext documents; and
a device for enabling a user to selectively move hyperlinks from any of said linked hypertext documents to said display window to thereby add said hyperlinks to the list of hyperlinks having potential interest.
